(19) United States
(12) Patent Application Publication
(10) Pub. No.: US 2025/0365113 A1
(43) Pub. Date: Nov. 27, 2025

(54) TIME DOMAIN WINDOW DETERMINING METHOD AND APPARATUS

(71) Applicant: HUAWEI TECHNOLOGIES CO., LTD., Shenzhen (CN)

(72) Inventors: Yue ZHOU, Shenzhen (CN); Xiaolei Tie, Shanghai (CN); Ying Chen, Hangzhou (CN)

(21) Appl. No.: 19/294,943

(22) Filed: Aug. 8, 2025

Related U.S. Application Data
(63) Continuation of application No. PCT/CN2024/076876, filed on Feb. 8, 2024.

(30) Foreign Application Priority Data
Feb. 10, 2023 (CN) 202310145142.6

(51) Int. Cl. H04L 5/00

(52) U.S. Cl. CPC H04L 5/0051; H04L 5/0064

(57) ABSTRACT

This application provides a time domain window determining method and an apparatus, which are applicable to a non-terrestrial network communication system, and are used to improve precision of determining duration of a nominal time domain window and/or an actual time domain window, to enhance a demodulation reference signal bundling gain. The method includes: determining the duration of the nominal time domain window based on at least one of a quantity of antenna combinations, duration of a group-based nominal time domain window, and a correction value of maximum DMRS bundling duration of a terminal apparatus; and determining the actual time domain window of the terminal apparatus based on the duration of the nominal time domain window.

### CROSS-REFERENCE TO RELATED APPLICATIONS

This application is a continuation of International Application No. PCT/CN2024/076876, filed on Feb. 8, 2024, which claims priority to Chinese Patent Application No. 202310145142.6, filed on Feb. 10, 2023. The disclosures of the aforementioned applications are hereby incorporated by reference in their entireties.

### TECHNICAL FIELD

This application relates to the field of mobile communication technologies, and in particular, to a time domain window determining method and an apparatus.

### BACKGROUND

A non-terrestrial network (non-terrestrial network, NTN) is an important part of 5th generation (5th generation, 5G) and future wireless communication networks, and is defined as a network or a network segment that uses a transmission device such as an airborne aircraft or a spaceborne aircraft as a relay node or a base station. Compared with a conventional terrestrial network, the non-terrestrial network has a key characteristic that the base station is deployed in the air or in space, or the base station performs signal transmission with a terminal device through a non-terrestrial device in the air or in space.

Currently, demodulation reference signal (demodulation reference signal, DMRS) bundling (bundling) is supported in the NTN. In the DMRS bundling, joint channel estimation can be performed based on DMRSs sent in a plurality of slots, which can improve accuracy of uplink channel estimation, thereby improving uplink channel coverage.

Enabling the DMRS bundling needs a sufficient time domain window (time domain window, TDW) size to be applicable to the DMRS bundling. Specifically, a nominal (nominal) time domain window (time domain window, TDW) needs to be determined based on a UE capability, and an actual TDW needs to be determined based on the nominal TDW. UE maintains power consistency and phase continuity within the actual TDW to support the DMRS bundling.

Currently, a granularity at which the UE determines the nominal TDW is excessively large. Consequently, precision of the actual TDW is low, and needs to be improved.

### SUMMARY

This application provides a time domain window determining method and an apparatus to improve precision of determining a nominal TDW and/or an actual TDW, to enhance a DMRS bundling gain.

According to a first aspect, a time domain window determining method is provided. The method may be implemented by a communication apparatus. The communication apparatus may be a component in a terminal device and/or a component in a network apparatus. A terminal apparatus may include the terminal device or the component in the terminal device, and the network apparatus may include a network device or the component in the network apparatus. A component in this application may include, for example, at least one of a chip, a chip system, a processor, a transceiver, a processing unit, or a transceiver unit. For example, an execution body is the communication apparatus. The method may be implemented by using the following steps: The communication apparatus may determine duration of a nominal time domain window based on at least one of a quantity of antenna combinations, duration of a group-based nominal time domain window, and a correction value of maximum DMRS bundling duration of the terminal apparatus. The group-based nominal time domain window corresponds to a group of terminal apparatuses, the group of terminal apparatuses includes the terminal apparatus, and the correction value of the maximum DMRS bundling duration is related to channel state information. In addition, the communication apparatus may determine an actual time domain window of the terminal apparatus based on the duration of the nominal time domain window.

According to the method shown in the first aspect, the communication apparatus may determine the duration of the nominal time domain window based on at least one of the quantity of antenna combinations, the duration of the group-based nominal time domain window, and the correction value of the maximum demodulation reference signal DMRS bundling duration of the terminal apparatus, instead of determining the duration only based on maximum demodulation reference signal DMRS bundling duration related to a terminal apparatus capability, and determine the actual time domain window based on the duration of the nominal time domain window. According to the method, precision of determining the duration of the nominal time domain window and/or the actual time domain window can be improved, and a DMRS bundling gain can be enhanced.

In addition, according to the method, overheads of explicitly indicating the duration by the network apparatus can be avoided during the duration of the nominal time domain window.

In a possible implementation, if the communication apparatus is the terminal apparatus, the communication apparatus may further maintain power consistency and phase continuity within the actual time domain window.

In a possible implementation, the communication apparatus may specifically determine the duration of the nominal time domain window based on the maximum DMRS bundling duration, continuous transmission time, and the quantity of antenna combinations of the terminal apparatus, where the continuous transmission time is determined based on resource scheduling information.

Based on this implementation, it can be ensured that possible space diversity can be traversed for continuously scheduled PUSCHs and/or PUCCHs, to maximize an uplink coverage capability brought by DMRS bundling and antenna switching. In addition, this solution balances the two coverage enhancement technologies: the DMRS bundling and antenna switching, so that a final uplink coverage capability is optimal.

In a possible implementation, the communication apparatus may specifically determine the duration of the nominal time domain window based on the maximum DMRS bundling duration, continuous transmission time, and the group-based nominal time domain window of the terminal apparatus, where the continuous transmission time is determined based on resource scheduling information.

In a possible implementation, the communication apparatus may specifically determine the duration of the nominal time domain window based on the maximum DMRS bundling duration, continuous transmission time, the quantity of antenna combinations, and the group-based nominal time domain window of the terminal apparatus, where the continuous transmission time is determined based on resource scheduling information.

In a possible implementation, the communication apparatus may specifically determine the duration of the nominal time domain window based on the maximum DMRS bundling duration, the correction value, and continuous transmission time of the terminal apparatus, where the continuous transmission time is determined based on resource scheduling information.

In a possible implementation, the communication apparatus may specifically determine the duration of the nominal time domain window based on the maximum DMRS bundling duration, the correction value, continuous transmission time, and the quantity of antenna combinations of the terminal apparatus, where the continuous transmission time is determined based on resource scheduling information.

In a possible implementation, the communication apparatus may specifically determine the duration of the nominal time domain window based on the maximum DMRS bundling duration, the correction value, continuous transmission time, and the group-based nominal time domain window of the terminal apparatus, where the continuous transmission time is determined based on resource scheduling information.

In a possible implementation, the communication apparatus may specifically determine the duration of the nominal time domain window based on the maximum DMRS bundling duration, the correction value, continuous transmission time, the quantity of antenna combinations, and the group-based nominal time domain window of the terminal apparatus, where the continuous transmission time is determined based on resource scheduling information.

In a possible implementation, if the communication apparatus is the terminal apparatus, the communication apparatus may further send first information. The first information indicates at least one of an index of an antenna working mode supported by the terminal apparatus, an index of a quantity of antenna combinations supported by the terminal apparatus, and the quantity of antenna combinations.

There may be a plurality of indexes of antenna working modes supported by the terminal apparatus, and the terminal apparatus may determine, based on scheduling information of the network apparatus, an antenna working mode to be used, and further determine a quantity of antenna combinations used by the terminal apparatus. Similarly, for the index of the quantity of antenna combinations supported by the terminal apparatus, the terminal apparatus may determine, based on the scheduling information of the network apparatus, a quantity of antenna combinations to be used. The quantity of antenna combinations of the terminal apparatus may be the quantity of antenna combinations used by the terminal apparatus.

In a possible implementation, the quantity of antenna combinations may include a quantity of antenna combinations corresponding to a data channel and/or a quantity of antenna combinations corresponding to a control channel. The quantity of antenna combinations used by the terminal apparatus may include a quantity of antenna combinations used by the data channel and/or a quantity of antenna combinations used by the control channel, and the quantity of antenna combinations supported by the terminal apparatus may include a quantity of antenna combinations supported by the data channel and/or a quantity of antenna combinations supported by the control channel.

In a possible implementation, if the first information is terminal capability information, and the communication apparatus is the terminal apparatus, the communication apparatus may receive a terminal capability query message from the network apparatus.

Based on this implementation, the terminal apparatus may report the first information by using the terminal capability query message, so that the network apparatus does not need to separately schedule the first information.

In a possible implementation, if the communication apparatus is the network apparatus, the communication apparatus may further send the terminal capability query message and receive the first information. The first information indicates at least one of the index of the antenna working mode supported by the terminal apparatus, the index of the quantity of antenna combinations supported by the terminal apparatus, and the quantity of antenna combinations.

Based on this implementation, the network apparatus may obtain the first information by using the capability query message, so that the network apparatus does not need to separately schedule the first information.

In a possible implementation, in the first information, the index of the antenna working mode supported by the terminal apparatus may include an index of an antenna working mode of a data channel supported by the terminal apparatus and/or an antenna working mode of a control channel supported by the terminal apparatus.

In a possible implementation, if the communication apparatus is the terminal apparatus, the communication apparatus may be further configured to receive the group-based nominal time domain window.

In a possible implementation, if the communication apparatus is the network apparatus, the communication apparatus may be further configured to send the group-based nominal time domain window.

In a possible implementation, the group-based nominal time domain window is included in a radio resource control message and/or a system information block.

Based on this implementation, the network apparatus may send the group-based nominal time domain window through RRC signaling or the system information block, to avoid sending through UE-level signaling, thereby reducing signaling overheads. Optionally, the group-based nominal time domain window may correspond to a beam index, to ensure that duration of a nominal time domain window of a terminal apparatus in each beam group is optimally selected in a case of a corresponding beam elevation angle.

In a possible implementation, the communication apparatus may further obtain a first correspondence, where the first correspondence includes a correspondence between a beam identifier and a group-based nominal time domain window, and query the first correspondence based on a beam identifier of the terminal apparatus to obtain the group-based nominal time domain window.

Based on this implementation, same information may be broadcast for different serving beams, to indicate the first correspondence, and then the group-based nominal time domain window is determined by serving beams accessed by different terminals, so that signaling overheads in a process of indicating the group-based nominal time domain window can be further reduced.

In a possible implementation, if the communication apparatus is the terminal apparatus, the terminal apparatus may further send the correction value.

In a possible implementation, if the communication apparatus is the network apparatus, the communication apparatus may further receive the correction value.

In a possible implementation, the correction value is included in the channel state information.

Based on this implementation, in a channel state information obtaining process, the network apparatus may obtain a change of a DMRS bundling length, due to a channel state change, that can be supported by the terminal.

According to a second aspect, a communication apparatus is provided. The apparatus may implement the method according to any possible design of the first aspect. The apparatus has a function of the foregoing communication apparatus. The apparatus is, for example, a terminal apparatus or a functional module in a terminal apparatus, or a network apparatus or a functional module in a network apparatus.

In an optional implementation, the apparatus may include modules that one-to-one correspond to the methods/operations/steps/actions described in the first aspect. The modules may be hardware circuits or software, or may be implemented by a combination of the hardware circuits and the software. In an optional implementation, the apparatus includes a processing unit (sometimes also referred to as a processing module) and a communication unit (sometimes also referred to as a transceiver module, a communication module, or the like). The transceiver unit can implement a sending function and a receiving function. When the transceiver unit implements the sending function, the transceiver unit may be referred to as a sending unit (sometimes also referred to as a sending module). When the transceiver unit implements the receiving function, the transceiver unit may be referred to as a receiving unit (sometimes also referred to as a receiving module). The sending unit and the receiving unit may be a same functional module, the functional module is referred to as the transceiver unit, and the functional module can implement the sending function and the receiving function. Alternatively, the sending unit and the receiving unit may be different functional modules, and the transceiver unit is a general term for these functional modules.

For example, when the apparatus is configured to perform the method described in the first aspect, the apparatus may include a communication unit and a processing unit.

The processing unit may be configured to determine duration of a nominal time domain window based on at least one of a quantity of antenna combinations, duration of a group-based nominal time domain window, and a correction value of maximum DMRS bundling duration of the terminal apparatus, and is configured to determine an actual time domain window of the terminal apparatus based on the duration of the nominal time domain window.

For a manner in which the processing unit determines the duration of the nominal time domain window, refer to the descriptions in the first aspect and the possible implementations of the first aspect. Details are not described herein again.

In addition, if the communication apparatus functions as the terminal apparatus, the communication unit may be configured to receive one or more of first information, a capability query message, the group-based nominal time domain window, and a first correspondence, or is configured to send the correction value of the maximum DMRS bundling duration.

If the communication apparatus functions as the terminal apparatus, the communication unit may be configured to send one or more of the first information, the capability query message, the group-based nominal time domain window, and the first correspondence, or is configured to receive the correction value of the maximum DMRS bundling duration.

For meanings of the foregoing technologies, refer to descriptions of the first aspect and the possible implementations of the first aspect. Details are not described again.

According to a third aspect, an embodiment of this application further provides a communication apparatus, including a processor, configured to execute a computer program (or computer executable instructions) stored in a memory. When the computer program (or the computer executable instructions) is executed, the apparatus is enabled to perform the method according to the first aspect and the possible implementations of the first aspect.

In a possible implementation, the processor and the memory are integrated together.

In another possible implementation, the memory is located outside the communication apparatus.

The communication apparatus further includes a communication interface. The communication interface is used for communication between the communication apparatus and another device, for example, for data and/or signal sending or receiving. For example, the communication interface may be a transceiver, a circuit, a bus, a module, or another type of communication interface.

According to a fourth aspect, a computer-readable storage medium is provided. The computer-readable storage medium is configured to store a computer program or instructions, and when the computer program or the instructions are run, the method shown in the first aspect and any possible implementation of the first aspect is implemented.

According to a fifth aspect, a computer program product including instructions is provided. When the computer program product runs on a computer, the method shown in the first aspect and any possible implementation of the first aspect is implemented.

According to a sixth aspect, an embodiment of this application further provides a communication apparatus, configured to perform the method according to the first aspect and the possible implementations of the first aspect.

According to a seventh aspect, a chip system is provided. The chip system includes a logic circuit (which may alternatively be understood as that the chip system includes a processor, and the processor may include a logic circuit, and the like), and may further include an input/output interface. The input/output interface may be configured to input a message, or may be configured to output a message. The input/output interface may be a same interface, that is, the same interface can implement both a sending function and a receiving function. Alternatively, the input/output interface includes an input interface and an output interface. The input interface is configured to implement the receiving function, that is, configured to receive a message. The output interface is configured to implement the sending function, that is, configured to send a message. The logic circuit may be configured to perform an operation other than the sending and receiving functions in the method shown in the first aspect and any possible implementation of the first aspect. The logic circuit may be further configured to transmit a message to the input/output interface, or receive, from the input/output interface, a message from another communication apparatus. The chip system may be configured to implement the method according to the first aspect and any possible implementation of the first aspect. The chip system may include a chip, or may include a chip and another discrete component.

Optionally, the chip system may further include a memory, and the memory may be configured to store instructions. The logic circuit may invoke the instructions stored in the memory to implement a corresponding function.

According to an eighth aspect, a communication system is provided. The communication system may include a terminal apparatus and a network apparatus. The terminal apparatus may be configured to perform the action performed by the communication apparatus or the non-network apparatus shown in the first aspect and any possible implementation of the first aspect, and the network device may be configured to perform the action performed by the communication apparatus or the non-terminal apparatus shown in the first aspect and any possible implementation of the first aspect.

For technical effects brought by the second aspect to the eighth aspect, refer to the descriptions of the first aspect. Details are not described herein again.

### BRIEF DESCRIPTION OF DRAWINGS

FIG. 1 is a diagram of an architecture of a wireless communication system according to an embodiment of this application;

FIG. 2 is a diagram of an architecture of another wireless communication system according to an embodiment of this application;

FIG. 3 is a diagram of an architecture of a network device according to an embodiment of this application;

FIG. 4 is a diagram of an architecture of another wireless communication system according to an embodiment of this application;

FIG. 5 is a schematic flowchart of a time domain window determining method according to an embodiment of this application;

FIG. 6 is a diagram of a relationship between a satellite beam and a service region according to an embodiment of this application;

FIG. 7 is a diagram of a structure of a communication apparatus according to an embodiment of this application;

FIG. 8 is a diagram of a structure of another communication apparatus according to an embodiment of this application; and

FIG. 9 is a diagram of a structure of another communication apparatus according to an embodiment of this application.

### DESCRIPTION OF EMBODIMENTS

The following further describes in detail this application with reference to accompanying drawings.

Embodiments of this application provide a time domain window determining method and an apparatus. The method and the apparatus in this application are based on a same technical concept. Because problem-resolving principles of the method and the apparatus are similar, mutual reference may be made to implementation of the apparatus and the method. Repeated parts are not described.

In the description of this application, words such as “first” and “second” are merely used for distinguishing between descriptions, and cannot be understood as an indication or implication of relative importance, or cannot be understood as an indication or implication of an order.

In the description of this application, “at least one (type)” means one (type) or more (types), and “a plurality of (types)” means two (types) or more (types). “At least one of the following items” or a similar expression thereof means any combination of these items, including any combination of singular items or plural items. For example, at least one of a, b, or c may indicate a, b, c, a and b, a and c, b and c, or a, b, and c, where a, b, and c may be singular or plural.

In the descriptions of this application, “and/or” describes an association relationship between associated objects, and indicates that three relationships may exist. For example, A and/or B may represent the following cases: Only A exists, both A and B exist, and only B exists, where A and B may be singular or plural. “/” indicates “or”. For example, a/b indicates a or b.

To describe the technical solutions in embodiments of this application more clearly, the following describes the method and the apparatus provided in embodiments of this application in detail with reference to the accompanying drawings.

The method provided in embodiments of this application may be applied to an NTN communication scenario. NTN communication may include devices such as an unmanned aerial vehicle, a high altitude platform (high altitude platform station, HAPS), or a satellite for networking, to provide services such as data transmission and voice communication for a terminal device. In addition, the NTN system may further include another air network device. This is not limited in this application.

With development of information technology, more urgent requirements are put forward for high efficiency, mobility, and diversity of communication. At present, the NTN communication plays an irreplaceable role in some important fields such as space communication, aeronautical communication, maritime communication, and military communication. The NTN communication has characteristics such as a long communication distance, a large coverage area, and flexible networking, and can provide services for both fixed terminals and various mobile terminals.

A conventional terrestrial network cannot provide seamless coverage for UE, especially in a place where a base station cannot be deployed, such as the sea, desert, or air. Therefore, a non-terrestrial network is introduced into a 5G system. The base station or some base station functions are deployed on the high altitude platform or the satellite, so that the non-terrestrial network provides seamless coverage for the UE, and the high altitude platform or the satellite is less affected by a natural disaster. This can improve reliability of the 5G system.

It may be understood that because a satellite orbit is far away from surface of the earth, a communication process between a terminal apparatus at the surface of the earth and a non-terrestrial device such as the satellite has characteristics such as a long distance and a large delay. Because of the long-distance characteristic, a path loss of the NTN communication is high. In this application, a signal-to-noise ratio (signal-to-noise ratio, SNR) or a signal to interference plus noise ratio (signal to interference plus noise ratio, SINR) may be used to represent the path loss.

In the NTN communication, working modes of an NTN device may include a transparent (transparent) mode and a regenerative (regenerative) mode. Based on the working modes of the NTN device, an NTN communication architecture may be classified into the following two types. One is a transparent forwarding architecture. In the architecture, the NTN device may be a relay (relay) or an amplifier, and may perform radio frequency filtering, amplification, and the like, to regenerate a physical layer signal. The NTN device may be responsible for layer 1 (L1) relay, and is configured to perform physical layer forwarding, and is invisible to a higher layer. The other is a regenerative architecture. In the architecture, the NTN device has a processing function of an access network device. For example, in the regenerative working mode, the satellite may be further classified into a regenerative satellite that does not have an inter-satellite link, that is, there is no inter-satellite link (inter-satellite link, ISL) between satellites; or a regenerative satellite that has an inter-satellite link, that is, there is an interface between satellites for direct data exchange, where the inter-satellite link uses an Xn interface; or a regenerative satellite that has a processing function of a distributed unit (distributed unit, DU) of the access network device, where in this scenario, the satellite functions as the DU.

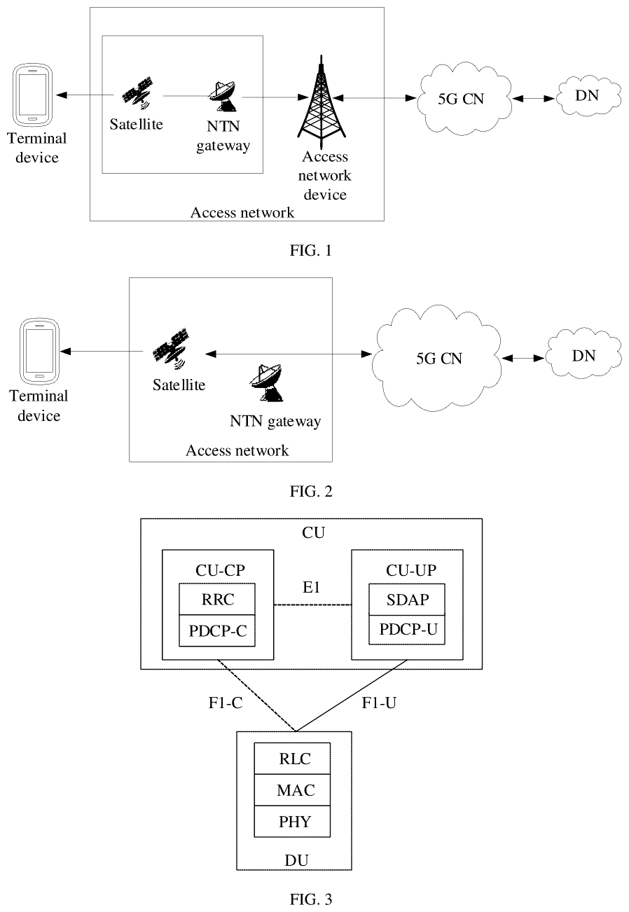

For example, FIG. 1 is a diagram of an NTN scenario to which an embodiment of this application is applicable. The NTN scenario may be an application scenario of a transparent forwarding architecture. In the scenario shown in FIG. 1, a terminal device may communicate with a 5G core network (core network, CN) through an access network, and then may be connected to a data network (data network, DN) through the 5G CN. A satellite and an NTN gateway (gateway) may be used as relay devices between the terminal device and an access network device, or as remote radio units (remote radio units, RRUs) of an access network device.

For example, FIG. 2 is a diagram of another NTN scenario to which an embodiment of this application is applicable. The NTN scenario may be an application scenario of the regenerative architecture. In the scenario shown in FIG. 2, the satellite may be used as the access network device, form an access network with an NTN gateway, and communicate with a core network through the NTN gateway. In addition, the satellite may further provide a wireless access service for a terminal apparatus. FIG. 2 shows an example of a regenerative satellite architecture without an inter-satellite link.

It should be noted that FIG. 1 and FIG. 2 show only one satellite and one NTN gateway. In actual use, an architecture with a plurality of satellites and/or a plurality of NTN gateways may be adopted based on a requirement. Each satellite may provide a service for one or more terminal devices, each NTN gateway may correspond to one or more satellites, and each satellite may correspond to one or more NTN gateways. This is not specifically limited in embodiments of this application.

It should be noted that FIG. 1 and FIG. 2 are merely examples of the NTN scenarios, and the NTN scenarios may further include another specific scenario. This is not limited in this application.

Devices in embodiments of this application include a terminal device, an access network device, and a core network device.

The terminal device is also referred to as user equipment (user equipment, UE), a mobile station (mobile station, MS), a mobile terminal (mobile terminal, MT), or the like, and is a device that provides voice and/or data connectivity for a user. For example, the terminal device may be a hand-held device, a vehicle-mounted device, or the like that has a wireless connection function. Currently, some examples of the terminal device may be as follows: a mobile phone (mobile phone), a tablet computer, a notebook computer, a palmtop computer, a mobile internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in a remote medical surgery (remote medical surgery), a wireless terminal in a smart grid (smart grid), a wireless terminal in transportation safety (transportation safety), a wireless terminal in a smart city (smart city), a wireless terminal in a smart home (smart home), and the like.

The access network device may be a radio access network (radio access network, RAN) node (or device) that enables the terminal device to access a wireless network, and may also be referred to as a base station. Currently, some examples of the RAN node may be as follows: a continuously evolved NodeB (gNB), a transmission reception point (transmission reception point, TRP), an evolved NodeB (evolved NodeB, eNB), a radio network controller (radio network controller, RNC), a NodeB (NodeB, NB), a base station controller (base station controller, BSC), a base transceiver station (base transceiver station, BTS), a home base station (for example, home evolved NodeB, or home NodeB, HNB), a baseband unit (baseband unit, BBU), a wireless fidelity (wireless fidelity, Wi-Fi) access point (access point, AP), or the like.

In addition, in a network structure, the access network device may include a central unit (central unit, CU) node, a DU node, or a RAN device including a CU node and a DU node. The RAN device that includes the CU node and the DU node splits protocol layers of a gNB in an NR system. Functions of a part of the protocol layers are centrally controlled by the CU, and functions of a part or all of remaining protocol layers are distributed in the DU, and the CU centrally controls the DU, as shown in FIG. 3. Further, the CU may be further divided into a control plane (CU-CP) and a user plane (CU-UP). The CU-CP is responsible for a control plane function, and mainly includes radio resource control (radio resource control, RRC) and a packet data convergence protocol (packet data convergence protocol, PDCP) (that is, PDCP-C) corresponding to the control plane. The PDCP-C is mainly responsible for data encryption/decryption, integrity protection, data transmission, and the like on the control plane. The CU-UP is responsible for a user plane function, and mainly includes a service data adaptation protocol (service data adaptation protocol, SDAP) and a PDCP (that is, PDCP-U) corresponding to the user plane. The SDAP is mainly responsible for processing data of a core network and mapping a flow (flow) to a bearer. The PDCP-U is mainly responsible for data plane encryption and decryption, integrity protection, header compression, sequence number maintenance, data transmission, and the like. The CU-CP and the CU-UP are connected through an El interface. The CU-CP, on behalf of the gNB, is connected to the core network through the NG interface and connected to the DU through an F1 interface-control plane (namely, F1-C). The CU-UP is connected to the DU through an F1 interface-user plane (namely, F1-U). Certainly, in another possible implementation, the PDCP-C is alternatively in the CU-UP.

It may be understood that in an NTN, the access network device may be deployed on the satellite or another non-terrestrial device, or may be deployed on the ground.

The core network device is a device in the core network that provides service support for the terminal device. Currently, some examples of the core network device are: an access and mobility management function (access and mobility management function, AMF) entity, a session management function (session management function, SMF) entity, a user plane function (user plane function, UPF) entity, and the like, which are not listed one by one herein. The AMF entity may be responsible for access management and mobility management of the terminal device. The SMF entity may be responsible for session management, for example, session establishment of a user. The UPF entity may be a functional entity on the user plane, and is mainly responsible for a connection to an external network. It should be noted that an entity in this application may also be referred to as a network element or a functional entity. For example, the AMF entity may also be referred to as an AMF network element or an AMF functional entity. For another example, the SMF entity may also be referred to as an SMF network element or an SMF functional entity.

In this application, the NTN supports communication between the UE and a non-terrestrial device. The non-terrestrial device may be used as an aircraft or a satellite that has a processing function of the access network device in the regenerative architecture, or may be used as a relay node or an amplifier that is deployed in the air or in the atmosphere and that has a processing function of the access network device in the transparent forwarding architecture. In the architecture shown in FIG. 1 or FIG. 2, the non-terrestrial device may include a satellite (or an aircraft or the like). In the architecture shown in FIG. 1 or FIG. 2, the satellite, the NTN gateway, the access network device, a node in the 5G CN, and a node in the DN may be collectively referred to as a network device, and the NTN gateway and the access network device may be collectively referred to as a ground station.

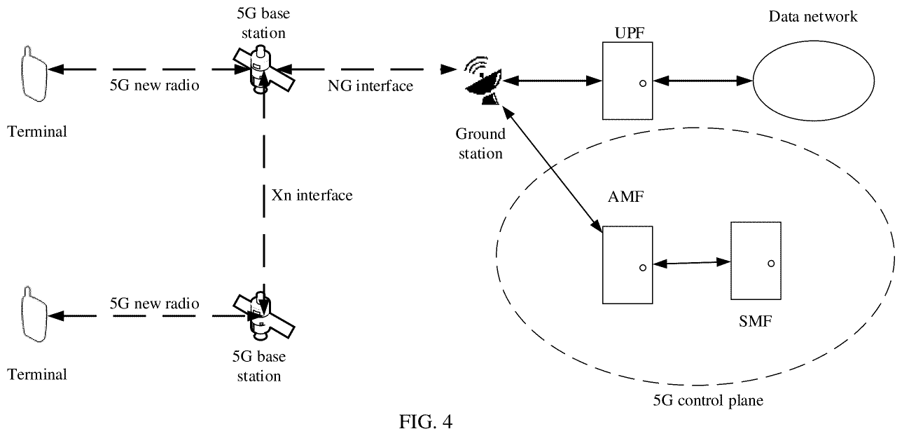

As shown in FIG. 4, the NTN may integrate satellite communication and 5G technologies. A terrestrial terminal may access a network through 5G new radio, and a 5G base station is deployed on a satellite. The 5G base station may be connected to a terrestrial core network through a radio link. In addition, a radio link exists between satellites, to complete signaling exchange and user data transmission between base stations.

It may be understood that a terminal in FIG. 4 is a mobile device supporting the 5G new radio, for example, a mobile device such as a mobile phone or a tablet computer (pad). The terminal may access a satellite network through an air interface and initiate services such as a call and internet access. The 5G base station in FIG. 4 is mainly configured to provide a wireless access service, schedule a radio resource for an access terminal, and provide a reliable wireless transmission protocol, a reliable data encryption protocol, and the like. A 5G core network may provide service such as user access control, mobility management, session management, user security authentication, and charging. The 5G core network may include a plurality of functional units, which may be classified into a control plane functional entity and a data plane functional entity. For example, an AMF may be responsible for user access management, security authentication, and mobility management. A UPF is responsible for managing functions such as user plane data transmission and traffic statistics collection. The ground station may be responsible for forwarding signaling and service data between a satellite base station and the 5G core network. The 5G new radio is a radio link between the terminal and the base station. An Xn interface is an interface between 5G base stations, and is mainly used for exchanging signaling, for example, a handover. An NG interface is an interface between the 5G base station and the 5G core network and is mainly used for exchanging NAS signaling of a core network and service data of a user.

Currently, in the NTN, uplink channel coverage enhancement effect can be obtained through DMRS bundling. The DMRS bundling is to combine DMRSs sent in a plurality of slots for joint channel estimation, which can improve accuracy of uplink channel estimation, thereby improving uplink channel coverage.

Enabling DMRS bundling needs a sufficient time domain window size to be applicable to the DMRS bundling, to meet a performance requirement of a service such as a voice over an Internet Protocol (Internet Protocol, IP) (voice over IP, VOIP) service.

A nominal TDW (or referred to as a nominal TDW) needs to be determined based on a UE capability, and an actual TDW needs to be determined based on the nominal TDW. UE maintains power consistency and phase continuity within the actual TDW to support the DMRS bundling.

Specifically, in processes such as PUSCH transmissions of a repetition type A, PUSCH transmissions of a PUSCH repetition type B, and PUSCH transmissions of transport block (transport block, TB) processing over multiple slots (transport block processing over multiple slots, TBoMS), duration of the nominal TDW of the UE meets the following conditions.

If a value of a PUSCH time domain window length (PUSCH-TimeDomainWindowLength) is configured for a network device, duration of each nominal TDW except a last nominal TDW is a quantity of PUSCH-TimeDomainWindowLength consecutive slots.

If PUSCH-TimeDomainWindowLength is not configured for the network device, the duration of each nominal TDW except the last nominal TDW is a quantity of min ([maxDMRS-BundlingDuration], M) consecutive slots. min(a, b) represents that a minimum value in a and b is selected; [maxDMRS-BundlingDuration] represents maximum duration of a nominal TDW limited by the UE capability, which may be referred to as maximum DMRS bundling duration; and M represents a time length in consecutive slots for N·K PUSCH transmissions.

For the PUSCH transmissions of the PUSCH repetition type A, N=1, and K represents a quantity of repetitions.

For the PUSCH transmissions of the PUSCH repetition type B, N=1, and K represents a quantity of nominal repetitions.

For the PUSCH transmissions of the TB processing over multiple slots, N represents a quantity of slots used for determining a transport block size (transport block size, TBS), and K represents a quantity of repetitions of the quantity N of slots used for determining the TBS.

For repeated PUCCH transmissions, the duration of the nominal TDW meets the following conditions.

If the PUCCH time domain window length (PUCCH-TimeDomain WindowLength) is configured for the network device, the duration of each nominal TDW except the last nominal TDW is given by PUCCH-TimeDomainWindowLength.

If PUCCH-TimeDomainWindowLength is not configured, the duration of each nominal TDW except the last nominal TDW is min ([maxDMRS-BundlingDuration], M). [maxDMRS-BundlingDuration] represents the maximum duration of the nominal TDW limited by the UE capability; and M represents a time length in consecutive slots from a first slot used for the repeated PUCCH transmissions to a last slot used for the repeated PUCCH transmissions. Optionally, M may be determined according to the clause 9.2.6 of the 3GPP technical specifications (technical specifications, TS) [6, TS 38.213].

In this application, within the actual TDW, the UE can maintain power consistency and phase continuity.

According to the current manner of determining the nominal TDW described above, when there is no indication from a network side, the duration of the nominal TDW is determined only by using the UE capability maxDMRS-BundlingDuration and scheduling information or grant information (that is, M) of the PUSCH or the PUCCH. In the current manner, a granularity is too large, and the duration of the nominal TDW cannot be accurately configured. Because a maximum DMRS bundling length that can be supported by a non-terrestrial device such as a satellite and the UE actually changes in different spatial locations, environments, or motion states, TDW calculation cannot be supported in conventional technologies based on a characteristic of a satellite communication scenario, and communication performance may be reduced.

To improve precision of determining the nominal TDW and/or the actual TDW, embodiments of this application provide a time domain window determining method and an apparatus. The method and the apparatus are based on a same concept. Because problem-resolving principles of the method and the apparatus are similar, mutual reference may be made to implementation of the apparatus and the method. Repeated parts are not described. The method may be performed by a communication apparatus. The communication apparatus may include a terminal apparatus and/or a network apparatus. The terminal apparatus may be a terminal device or a component in a terminal device. The network apparatus may be a network device or a component in a network device. The network device may include a non-terrestrial device (or a non-terrestrial apparatus). The non-terrestrial device may be a device such as an aircraft or a satellite. The non-terrestrial device may have a function of an access network device, or only play a transparent transmission function. The component in this application may be at least one of a chip, a chip system, a processor, a transceiver, a processing unit, or a transceiver unit. For example, for the terminal device, the component may include a radio transceiver module, and for the access network device, the component may include a CU, a DU, or the like.

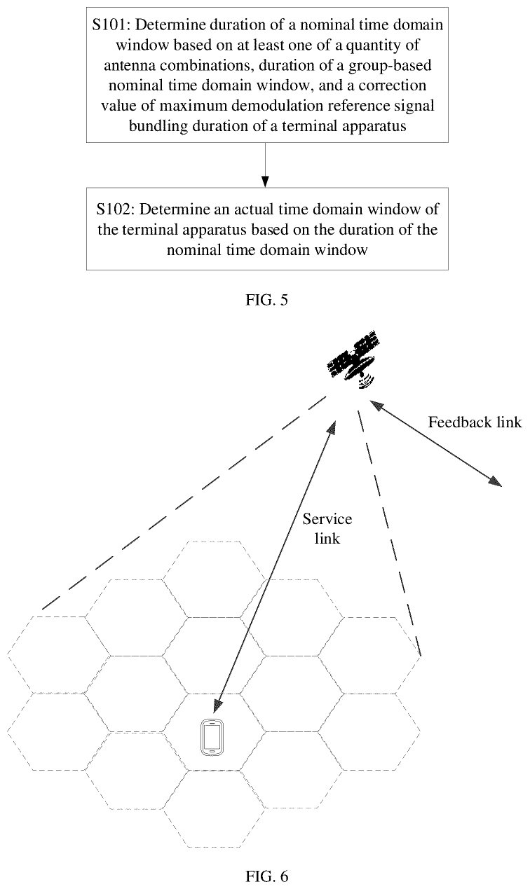

As shown in FIG. 5, an example in which an execution body is the communication apparatus is used. The time domain window determining method provided in this embodiment of this application may include the following steps.

S101: The communication apparatus determines duration of a nominal time domain window based on at least one of a quantity of antenna combinations, duration of a group-based nominal time domain window, and a correction value of maximum demodulation reference signal bundling duration of the terminal apparatus.

The following separately describes the quantity of antenna combinations, the duration of the group-based nominal time domain window, and the correction value of the maximum demodulation reference signal bundling duration of the terminal apparatus.

(1) The quantity of antenna combinations of the terminal apparatus is a quantity of antenna combinations included in an antenna working mode used by the terminal apparatus. For example, the antenna working mode of the terminal apparatus is represented as xTyRz, which indicates that the terminal apparatus simultaneously sends uplink data and/or control channel signals over x antennas in z combinations of y antennas, where z represents the quantity of antenna combinations. xTyRz may correspond to an index, which is referred to as an index of the antenna working mode. Therefore, the antenna working mode may be represented by using the index. For example, a code 00 represents 1T4R4, and 00 is an index of the antenna working mode 1T4R4.

In this application, a data channel includes but is not limited to a PUSCH, and a control channel includes but is not limited to a PUCCH.

For example, in 1T4R4, the terminal apparatus uses four antennas for transmissions in turn, and one of the antennas is used for each transmission. In this case, the quantity of antenna combinations is four. In 2T4R2, the terminal apparatus may switch transmission in turn on two groups of antennas fixed on four antennas, and each group includes two antennas. The terminal apparatus supports a total of two possible antenna combinations, that is, the quantity of antenna combinations is two. In 2T4R4, the terminal apparatus may switch transmission in turn on four groups of antennas on four antennas, and each group includes two antennas. The terminal apparatus supports a total of four possible antenna combinations, that is, the quantity of antenna combinations is four.

In addition, the quantity of antenna combinations of the terminal apparatus may be specific to the data channel and/or the control channel, or different quantities of antenna combinations may be respectively used for the data channel and the control channel. When duration of a nominal time domain window corresponding to the data channel is determined, the quantity of antenna combinations corresponding to the data channel may be used; and/or when duration of a nominal time domain window corresponding to the control channel is determined, the quantity of antenna combinations corresponding to the control channel may be used. In other words, a quantity of antenna combinations used by the terminal apparatus may include a quantity of antenna combinations used by the data channel and/or a quantity of antenna combinations used by the control channel, and the quantity of antenna combinations supported by the terminal apparatus may include a quantity of antenna combinations supported by the data channel and/or a quantity of antenna combinations supported by the control channel. In a possible implementation of S101, the terminal apparatus may send first

information to the network apparatus. The first information may include at least one of information about the antenna working mode supported by the terminal apparatus (for example, the index of the antenna working mode supported by the terminal apparatus), the index of the quantity of antenna combinations supported by the terminal apparatus, and the quantity of antenna combinations of the terminal apparatus.

The terminal apparatus may support a plurality of antenna working modes. During a data or signaling transmission, the network apparatus may indicate one of the antenna working modes based on scheduling information. In this case, the terminal apparatus and/or the network apparatus may use a quantity of antenna combinations corresponding to a corresponding antenna working mode to determine the duration of the nominal time domain window of the terminal apparatus. For example, indexes of supported antenna working modes reported by the terminal apparatus represent 1T4R4 and 2T4R2. If the network device indicates, based on the scheduling information, that the terminal apparatus uses IT for sending, correspondingly, the terminal apparatus may determine, based on 1T4R4, that the quantity of antenna combinations is 4. If the network device indicates, based on the scheduling information, that the terminal apparatus uses 2T for sending, correspondingly, the terminal apparatus may determine, based on 2T4R2, that the quantity of antenna combinations is 2.

Optionally, the index of the antenna working mode supported by the terminal apparatus may include an index of an antenna working mode of the data channel supported by the terminal apparatus and/or an antenna working mode of the control channel supported by the terminal apparatus. For example, the antenna working mode corresponding to the data channel and the antenna working mode corresponding to the control channel may be separately numbered.

Similarly, for the index of the quantity of antenna combinations supported by the terminal apparatus, the terminal apparatus may determine, based on the scheduling information of

In addition, the quantity of antenna combinations of the terminal apparatus may be the quantity of antenna combinations used by the terminal apparatus, and may have a unique value. For example, when the terminal apparatus supports 1T4R4 and 2T4R4, a quantity of antenna combinations reported by the terminal apparatus is 4, and the terminal apparatus and/or the network apparatus may determine the duration of the nominal time domain window of the terminal apparatus based on the value.

In a possible example, the first information may be sent based on scheduling of the network apparatus. For example, the first information is terminal capability information, and at least one of the information (like the index) about the antenna working mode supported by the terminal apparatus, the index of the quantity of antenna combinations supported by the terminal apparatus, and the quantity of antenna combinations of the terminal apparatus, and/or the quantity of antenna combinations may be included in the terminal capability information. Optionally, the network device may send scheduling information to the terminal apparatus, to schedule the terminal capability information. Alternatively, the terminal capability information may be sent based on other scheduling information not used for dedicated scheduling capability information. This is not specifically limited in this application.

In another example, the first information may be included in RRC signaling. To be specific, at least one of the information (like the index) about the antenna working mode, the index of the quantity of antenna combinations supported by the terminal apparatus, and the quantity of antenna combinations of the terminal apparatus may be included in the RRC signaling. Alternatively, in other words, the first information is RRC signaling. Optionally, the network apparatus may request the capability information from the terminal apparatus through the RRC signaling (for example, a UE capability obtaining (UECapabilityEnquiry) message or a UE capability query message). The terminal apparatus may carry at least one of the information (like the index) about the antenna working mode, the index of the quantity of antenna combinations supported by the terminal apparatus, and the quantity of antenna combinations of the terminal apparatus when reporting the capability information through the RRC signaling (for example, a UE capability information (UECapabilityInformation) message). Therefore, the network apparatus does not need to separately schedule the first information.

(2) The group-based nominal time domain window, or referred to as the duration of the group-based nominal time domain window, may correspond to a group of terminal apparatuses, and the group of terminal apparatuses includes the terminal apparatus.

The group-based nominal time domain window may correspond to a serving beam. For example, when serving beams of a plurality of terminal apparatuses are the same, the plurality of terminal apparatuses are a group of terminal apparatuses, and a same group-based nominal time domain window is used.

As shown in FIG. 6, different serving beams correspond to different service regions. In FIG. 6, a hexagon area represents a service region of one beam. Therefore, at a moment, distances (or transmission delays) between terminal apparatuses in service regions of a same serving beam and a same non-terrestrial device are close. Therefore, a same group-based nominal time domain window may be configured for a group of terminal apparatuses.

In a possible manner of obtaining the group-based nominal time domain window, the network apparatus may determine, based on a serving beam of the terminal apparatus, a serving beam corresponding to the serving beam. The network apparatus may query, based on beam information of the serving beam of the terminal apparatus, a correspondence (which may be referred to as a first correspondence) between the beam information and the group-based nominal time domain window, to obtain a group-based nominal time domain window corresponding to the serving beam. In addition, the network apparatus may further send, in a broadcast or multicast manner, an RRC message and/or a system information block (system information block, SIB) to a terminal apparatus in a range of the serving beam by using the serving beam, where the RRC message and/or the system information block carry a group-based nominal time domain window corresponding to the serving beam, and the terminal apparatus in the service region of the serving beam may receive the group-based nominal time domain window.

Therefore, the network apparatus does not need to indicate the group-based nominal time domain window to the terminal apparatus through UE-level signaling, thereby reducing signaling overheads. In addition, because the group-based nominal time domain window may correspond to a beam index, or the group-based nominal time domain window may be configured for a beam index, it can be ensured that duration of a nominal time domain window of a terminal apparatus in each beam group is optimally selected in a case of a corresponding beam elevation angle.

In addition, optionally, the first correspondence may be sent by the network device in the broadcast or multicast manner. When the duration of the nominal time domain window of the terminal apparatus is determined, the terminal apparatus and/or the network apparatus may query the first correspondence based on information about the serving beam of the terminal apparatus, to obtain a group-based nominal time domain window of a group of terminal apparatuses to which the terminal apparatus belongs, and determine the duration of the nominal time domain window of the terminal apparatus based on the group-based nominal time domain window. Based on this implementation, same information may be broadcast for different serving beams, to indicate the first correspondence, and then the group-based nominal time domain window is determined by serving beams of different terminal apparatuses, so that signaling overheads in a process of indicating the group-based nominal time domain window can be further reduced.

Optionally, the first correspondence may include a correspondence between a group-based nominal time domain window, and a synchronization signal of a beam and a physical broadcast channel (physical broadcast channel, PBCH) block (synchronization signal and PBCH block, SSB) index (SSB index). Correspondingly, the terminal apparatus and/or the network apparatus may query the first correspondence based on an SSB index of a serving beam on which the terminal apparatus is located, to obtain the group-based nominal time domain window.

(3) The correction value of the maximum DMRS bundling duration is related to channel state information.

Optionally, the correction value may be a value reported by the terminal apparatus to the network apparatus. Further, optionally, the network apparatus may receive independently the correction value reported by the terminal apparatus.

In addition, optionally, the terminal apparatus may carry the correction value in the channel state information (channel state information, CSI), and report the channel state information to the network apparatus. Therefore, in a CSI obtaining process, the network apparatus may obtain a change of a DMRS bundling length, due to a channel state change, that can be supported by the terminal.

It may be understood that determining the duration of the nominal time domain window of the terminal apparatus based on the correction value can optimize optimal selection of the duration of the nominal time domain window when a channel on the network side and a channel on the terminal side change, to improve the precision of determining the duration of the nominal time domain window and/or the actual time domain window.

Optionally, the correction value may be determined based on the following method.

For example, when the terminal apparatus perceives that a Doppler change rate of a communication signal between the terminal apparatus and the network apparatus becomes fast, the duration of the nominal time domain window needs to be shortened. In addition, when the Doppler change rate becomes slow, the nominal time domain window may be increased. The terminal apparatus may output, based on the foregoing change trend of the Doppler change rate, a representation parameter of a correction amount or a correction value agreed with the network side, so that the network apparatus learns the correction value.

For another example, when the terminal apparatus perceives that a timing offset change rate of a communication signal between the terminal apparatus and the network apparatus becomes fast, the nominal time domain window needs to be shortened. In addition, when the timing offset change rate becomes slow, the nominal time domain window may need to be increased. The terminal apparatus may output, based on the foregoing change trend of the timing offset change rate, a representation parameter of a correction amount or a correction value agreed with the network side, so that the network apparatus learns the correction value.

It may be understood that one or more of the quantity of antenna combinations, the group-based nominal time domain window, and the correction value of the maximum DMRS bundling duration may be obtained between the terminal apparatus and the network apparatus. Obtaining one of the parameters does not mean that the duration of the nominal time domain window needs to be determined by using the parameter. A specific parameter or parameters used to determine the nominal time domain window may be agreed on by the terminal apparatus and the network apparatus, or may be determined through preconfiguration or predefinition.

With reference to Manner 1 to Manner 7, the following describes a manner of determining the duration of the nominal time domain window of the terminal apparatus provided in this embodiment of this application.

Manner 1: In an example of determining the duration of the nominal time domain window of the terminal apparatus based on the quantity of antenna combinations, the communication apparatus may determine the duration of the nominal time domain window based on the maximum DMRS bundling duration, continuous transmission time, and the quantity of antenna combinations of the terminal apparatus.

For example, the duration of the nominal time domain window of the terminal apparatus is min ([maxDMRS-BundlingDuration], M/z). maxDMRS-BundlingDuration represents the maximum DMRS bundling duration. For the PUSCH, M represents a quantity of consecutive slots for N·K PUSCH transmissions. For the PUCCH, M represents a quantity of consecutive slots from a first slot used for repeated PUCCH transmissions to a last slot used for the repeated PUCCH transmissions. z represents the quantity of antenna combinations of the terminal apparatus. a/b represents that a is divided by b. In other words, the duration of the nominal time domain window of the terminal apparatus is a minimum value in the maximum DMRS bundling duration and (M/z).

Optionally, when PUSCH-DMRS-Bundling is enabled and the network device does not indicate PUSCH-TimeDomain WindowLength, min ([maxDMRS-BundlingDuration], M/z) is used as duration of a nominal time domain window for a PUSCH transmission of the terminal apparatus. M represents the quantity of consecutive slots for the N·K PUSCH transmissions.

In addition, when PUCCH-DMRS-Bundling is enabled and the network device does not indicate PUCCH-TimeDomain WindowLength, min ([maxDMRS-BundlingDuration], M/z) is used as duration of a nominal time domain window for a PUCCH transmission of the terminal apparatus. M represents the quantity of consecutive slots from the first slot used for the repeated PUCCH transmissions to the last slot used for the repeated PUCCH transmissions.

Based on the manner 1 and another manner of determining the duration of the nominal time domain window of the terminal apparatus based on (M/z), it can be ensured that possible space diversity can be traversed for continuously scheduled PUSCHs and/or PUCCHs, to maximize an uplink coverage capability brought by DMRS bundling and antenna switching. In addition, this solution balances the two coverage enhancement technologies: the DMRS bundling and antenna switching, so that a final uplink coverage capability is optimal.

Manner 2: In an example of determining the duration of the nominal time domain window of the terminal apparatus based on the group-based nominal time domain window, the communication apparatus may determine the duration of the nominal time domain window based on the maximum DMRS bundling duration, continuous transmission time, and the group-based nominal time domain window of the terminal apparatus.

For example, the duration of the nominal time domain window of the terminal apparatus is min ([maxDMRS-BundlingDuration], M, groupNominalTDW). maxDMRS-BundlingDuration represents the maximum DMRS bundling duration. For the PUSCH, M represents a quantity of consecutive slots for N·K PUSCH transmissions. For the PUCCH, M represents a quantity of consecutive slots from a first slot used for repeated PUCCH transmissions to a last slot used for the repeated PUCCH transmissions. groupNominalTDW represents the group-based nominal time domain window. In other words, the duration of the nominal time domain window of the terminal apparatus is a minimum value in the maximum DMRS bundling duration, M, and the group-based nominal time domain window.

Optionally, when PUSCH-DMRS-Bundling is enabled and the network device does not indicate PUSCH-TimeDomain WindowLength, min ([maxDMRS-BundlingDuration], M, groupNominalTDW) is used as duration of a nominal time domain window for a PUSCH transmission of the terminal apparatus. M represents the quantity of consecutive slots for the N·K PUSCH transmissions.

In addition, when PUCCH-DMRS-Bundling is enabled and the network device does not indicate PUCCH-TimeDomainWindowLength, min ([maxDMRS-BundlingDuration], M, groupNominalTDW) is used as duration of a nominal time domain window for a PUCCH transmission of the terminal apparatus. M represents the quantity of consecutive slots from the first slot used for the repeated PUCCH transmissions to the last slot used for the repeated PUCCH transmissions.

Manner 3: In an example of determining the duration of the nominal time domain window of the terminal apparatus based on the correction value of the maximum DMRS bundling duration, the communication apparatus may determine the duration of the nominal time domain window based on the maximum DMRS bundling duration, continuous transmission time, and the correction value of the maximum DMRS bundling duration of the terminal apparatus.

For example, the duration of the nominal time domain window of the terminal apparatus is min ([maxDMRS-BundlingDuration−modifyDMRS-BundlingDuration], M). maxDMRS-BundlingDuration represents the maximum DMRS bundling duration. For the PUSCH, M represents a quantity of consecutive slots for N·K PUSCH transmissions. For the PUCCH, M represents a quantity of consecutive slots from a first slot used for repeated PUCCH transmissions to a last slot used for the repeated PUCCH transmissions. modifyDMRS-BundlingDuration represents the correction value of the maximum DMRS bundling duration. “−” represents a subtraction operation. In other words, the duration of the nominal time domain window of the terminal apparatus is a minimum value in M and a calculation result obtained by subtracting the correction value of the maximum DMRS bundling duration from the maximum DMRS bundling duration.

Manner 4: In an example of determining the duration of the nominal time domain window of the terminal apparatus based on the quantity of antenna combinations and the group-based nominal time domain window, the communication apparatus may determine the duration of the nominal time domain window based on the maximum DMRS bundling duration, continuous transmission time, the quantity of antenna combinations, and the group-based nominal time domain window of the terminal apparatus.

For example, the duration of the nominal time domain window of the terminal apparatus is min ([maxDMRS-BundlingDuration], M/z, groupNominalTDW). maxDMRS-BundlingDuration represents the maximum DMRS bundling duration. For the PUSCH, M represents a quantity of consecutive slots for N·K PUSCH transmissions. For the PUCCH, M represents a quantity of consecutive slots from a first slot used for repeated PUCCH transmissions to a last slot used for the repeated PUCCH transmissions. z represents the quantity of antenna combinations of the terminal apparatus. a/b represents that a is divided by b. groupNominalTDW represents the group-based nominal time domain window. In other words, the duration of the nominal time domain window of the terminal apparatus is a minimum value in the maximum DMRS bundling duration, (M/z), and the group-based nominal time domain window.

Optionally, when PUSCH-DMRS-Bundling is enabled and the network device does not indicate PUSCH-TimeDomain WindowLength, min ([maxDMRS-BundlingDuration], M/z, groupNominalTDW) is used as duration of a nominal time domain window for a PUSCH transmission of the terminal apparatus. M represents the quantity of consecutive slots for the N·K PUSCH transmissions.

In addition, when PUCCH-DMRS-Bundling is enabled and the network device does not indicate PUCCH-TimeDomainWindowLength, min ([maxDMRS-BundlingDuration], M/z, groupNominalTDW) is used as duration of a nominal time domain window for a PUCCH transmission of the terminal apparatus. M represents the quantity of consecutive slots from the first slot used for the repeated PUCCH transmissions to the last slot used for the repeated PUCCH transmissions.

Manner 5: In an example of determining the duration of the nominal time domain window of the terminal apparatus based on the quantity of antenna combinations and the correction value of the maximum DMRS bundling duration, the communication apparatus may determine the duration of the nominal time domain window based on the maximum DMRS bundling duration, continuous transmission time, the quantity of antenna combinations, and the correction value of the maximum DMRS bundling duration of the terminal apparatus.

For example, the duration of the nominal time domain window of the terminal apparatus is min ([maxDMRS-BundlingDuration−modifyDMRS-BundlingDuration], M/z). maxDMRS-BundlingDuration represents the maximum DMRS bundling duration. For the PUSCH, M represents a quantity of consecutive slots for N·K PUSCH transmissions. For the PUCCH, M represents a quantity of consecutive slots from a first slot used for repeated PUCCH transmissions to a last slot used for the repeated PUCCH transmissions. z represents the quantity of antenna combinations of the terminal apparatus. a/b represents that a is divided by b. modifyDMRS-BundlingDuration represents the correction value of the maximum DMRS bundling duration. In other words, the duration of the nominal time domain window of the terminal apparatus is a minimum value in (M/z) and a calculation result obtained by subtracting the correction value of the maximum DMRS bundling duration from the maximum DMRS bundling duration.

Optionally, when PUSCH-DMRS-Bundling is enabled and the network device does not indicate PUSCH-TimeDomain WindowLength, min ([maxDMRS-BundlingDuration−modifyDMRS-BundlingDuration], M/z) is used as duration of a nominal time domain window for a PUSCH transmission of the terminal apparatus. M represents the quantity of consecutive slots for the N·K PUSCH transmissions.

In addition, when PUCCH-DMRS-Bundling is enabled and the network device does not indicate PUCCH-TimeDomainWindowLength, min ([maxDMRS-BundlingDuration−modifyDMRS-BundlingDuration], M/z) is used as duration of a nominal time domain window for a PUCCH transmission of the terminal apparatus. M represents the quantity of consecutive slots from the first slot used for the repeated PUCCH transmissions to the last slot used for the repeated PUCCH transmissions.

Manner 6: In an example of determining the duration of the nominal time domain window of the terminal apparatus based on the group-based nominal time domain window and the correction value of the maximum DMRS bundling duration, the communication apparatus may determine the duration of the nominal time domain window based on the maximum DMRS bundling duration, continuous transmission time, the correction value of the maximum DMRS bundling duration, and the group-based nominal time domain window of the terminal apparatus.

For example, the duration of the nominal time domain window of the terminal apparatus is min ([maxDMRS-BundlingDuration−modifyDMRS-BundlingDuration], M, groupNominalTDW). maxDMRS-BundlingDuration represents the maximum DMRS bundling duration. For the PUSCH, M represents a quantity of consecutive slots for N·K PUSCH transmissions. For the PUCCH, M represents a quantity of consecutive slots from a first slot used for repeated PUCCH transmissions to a last slot used for the repeated PUCCH transmissions. modifyDMRS-BundlingDuration represents the correction value of the maximum DMRS bundling duration. groupNominalTDW represents the group-based nominal time domain window. In other words, the duration of the nominal time domain window of the terminal apparatus is a minimum value in M, the group-based nominal time domain window, and a calculation result obtained by subtracting the correction value of the maximum DMRS bundling duration from the maximum DMRS bundling duration.

Optionally, when PUSCH-DMRS-Bundling is enabled and the network device does not indicate PUSCH-TimeDomain WindowLength, min ([maxDMRS-BundlingDuration−modifyDMRS-BundlingDuration], M, groupNominalTDW) is used as duration of a nominal time domain window for a PUSCH transmission of the terminal apparatus. M represents the quantity of consecutive slots for the N·K PUSCH transmissions.

In addition, when PUCCH-DMRS-Bundling is enabled and the network device does not indicate PUCCH-TimeDomainWindowLength, min ([maxDMRS-BundlingDuration−modifyDMRS-BundlingDuration], M, groupNominalTDW) is used as duration of a nominal time domain window for a PUCCH transmission of the terminal apparatus. M represents the quantity of consecutive slots from the first slot used for the repeated PUCCH transmissions to the last slot used for the repeated PUCCH transmissions.

Manner 7: In an example of determining the duration of the nominal time domain window of the terminal apparatus based on the quantity of antenna combinations, the group-based nominal time domain window, and the correction value of the maximum DMRS bundling duration, the communication apparatus may determine the duration of the nominal time domain window based on the maximum DMRS bundling duration, continuous transmission time, the quantity of antenna combinations, the correction value of the maximum DMRS bundling duration, and the group-based nominal time domain window of the terminal apparatus.

For example, the duration of the nominal time domain window of the terminal apparatus is min ([maxDMRS-BundlingDuration−modifyDMRS-BundlingDuration], M/z, groupNominalTDW). maxDMRS-BundlingDuration represents the maximum DMRS bundling duration. For the PUSCH, M represents a quantity of consecutive slots for N·K PUSCH transmissions. For the PUCCH, M represents a quantity of consecutive slots from a first slot used for repeated PUCCH transmissions to a last slot used for the repeated PUCCH transmissions. modifyDMRS-BundlingDuration represents the correction value of the maximum DMRS bundling duration. z represents the quantity of antenna combinations of the terminal apparatus. a/b represents that a is divided by b. groupNominalTDW represents the group-based nominal time domain window. In other words, the duration of the nominal time domain window of the terminal apparatus is a minimum value in (M/z), the group-based nominal time domain window, and a calculation result obtained by subtracting the correction value of the maximum DMRS bundling duration from the maximum DMRS bundling duration.

Optionally, when PUSCH-DMRS-Bundling is enabled and the network device does not indicate PUSCH-TimeDomain WindowLength, min ([maxDMRS-BundlingDuration−modifyDMRS-BundlingDuration], M/z, groupNominalTDW) is used as duration of a nominal time domain window for a PUSCH transmission of the terminal apparatus. M represents the quantity of consecutive slots for the N·K PUSCH transmissions.

In addition, when PUCCH-DMRS-Bundling is enabled and the network device does not indicate PUCCH-TimeDomainWindowLength, min ([maxDMRS-BundlingDuration−modifyDMRS-BundlingDuration], M/z, groupNominalTDW) is used as duration of a nominal time domain window for a PUCCH transmission of the terminal apparatus. M represents the quantity of consecutive slots from the first slot used for the repeated PUCCH transmissions to the last slot used for the repeated PUCCH transmissions.

Optionally, in Manner 3 and Manner 5 to Manner 7, modifyDMRS-BundlingDuration may also represent a scaling ratio value of maxDMRS-BundlingDuration. In this case, “maxDMRS-BundlingDuration−modifyDMRS-BundlingDuration” may be replaced with “maxDMRS-BundlingDuration*modifyDMRS-BundlingDuration” or “maxDMRS-BundlingDuration/modifyDMRS-BundlingDuration”. In addition, “maxDMRS-BundlingDuration−modifyDMRS-BundlingDuration” may also be replaced with “maxDMRS-BundlingDuration+modifyDMRS-BundlingDuration”, where a symbol of a value of modifyDMRS-BundlingDuration in “maxDMRS-BundlingDuration−modifyDMRS-BundlingDuration” is opposite to that of a value of modifyDMRS-BundlingDuration in “maxDMRS-BundlingDuration+modifyDMRS-BundlingDuration”.

It may be understood that Manner 1 to Manner 7 are examples for descriptions of determining the duration of the nominal time domain window of the terminal apparatus. Based on an actual requirement, simple extension may be performed on the basis of the foregoing examples. For example, a solution obtained by transforming a polynomial that the duration meets, or by arranging and combining the examples still belongs to the method provided in this application. Specific parameters that are used by the terminal apparatus and/or the network apparatus to determine the duration of the nominal time domain window of the terminal apparatus may be agreed on between the terminal apparatus and the network apparatus through signaling, or may be indicated by the network apparatus through signaling, or may be determined through preconfiguration or predefinition.

In addition, Manner 1 to Manner 7 can avoid overheads of explicitly indicating PUSCH-TimeDomainWindowLength and/or PUCCH-TimeDomainWindowLength by the network apparatus.

Optionally, in this application, when PUSCH-DMRS-Bundling is enabled and the network apparatus indicates PUSCH-TimeDomainWindowLength to the terminal apparatus, the terminal apparatus and/or the network apparatus may use PUSCH-TimeDomainWindowLength as duration of a nominal time domain window for a PUSCH transmission of the terminal apparatus. Similarly, in this application, when PUCCH-DMRS-Bundling is enabled and the network apparatus indicates PUCCH-TimeDomainWindowLength to the terminal apparatus, the terminal apparatus and/or the network apparatus may use PUCCH-TimeDomainWindowLength as duration of a nominal time domain window for a PUCCH transmission of the terminal apparatus.

S102: The communication apparatus determines an actual time domain window of the terminal apparatus based on the duration of the nominal time domain window.

The following describes, by using an example, a manner in which the communication apparatus determines the actual time domain window in this application.

For PUSCH transmissions of a PUSCH repetition type A scheduled by a DCI format 0_1 or a DCI format 0_2, a PUSCH repetition type A with a configured grant, a PUSCH repetition type B, and TB processing over multiple slots, a nominal TDW includes one or more actual TDWs. The UE determines the actual TDW in the following manner.

First, a start of a first actual TDW is a first symbol of a first PUSCH transmission in a plurality of slots for the PUSCH transmissions of the PUSCH repetition type A scheduled by the DCI format 0_1 or the DCI format 0_2, or the PUSCH repetition type A with the configured grant, or the PUSCH repetition type B, or the TB processing over multiple slots within the nominal TDW.

In addition, an end of an actual TDW is:
a last symbol of the PUSCH transmissions of the PUSCH repetition type A scheduled by the DCI format 0_1 or the DCI format 0_2, or the PUSCH repetition type A with the configured grant, or the PUSCH repetition type B, or the TB processing over multiple slots within the nominal TDW, if the actual TDW reaches an end of a last PUSCH transmission within the nominal TDW; or
a last symbol of a PUSCH transmission before an event, if the event occurs which causes power consistency and phase continuity not to be maintained within the nominal time domain window across the PUSCH transmissions of the PUSCH repetition type A scheduled by the DCI format 0_1 or the DCI format 0_2, or the PUSCH transmissions of the PUSCH repetition type A with the configured grant, or the PUSCH transmissions of the PUSCH repetition type B, or the PUSCH transmissions of the TB processing over multiple slots within the nominal TDW, and the PUSCH transmission is in a slot for the PUSCH transmissions of the PUSCH repetition type A scheduled by the DCI format 0_1 or the DCI format 0_2, or the PUSCH repetition type A with the configured grant, or the PUSCH repetition type B, or the TB processing over multiple slots.

When PUSCH window restart (PUSCH-Window-Restart) is enabled, a start of a new actual TDW is a first symbol of a PUSCH transmission after the event which causes power consistency and phase continuity not to be maintained within the nominal time domain window across the PUSCH transmissions of the PUSCH repetition type A scheduled by the DCI format 0_1 or the DCI format 0_2, or the PUSCH repetition type A with the configured grant, or the PUSCH repetition type B, or the TB processing over multiple slots within the nominal TDW, and the PUSCH transmission is in the slot for the PUSCH transmissions of the PUSCH repetition type A scheduled by the DCI format 0_1 or the DCI format 0_2, or the PUSCH repetition type A with the configured grant, or the PUSCH repetition type B, or the TB processing over multiple slots.

For PUCCH transmissions of a PUCCH repetition, a nominal TDW includes one or more actual TDWs. The UE determines the actual TDW in the following manner.

A start of a first actual TDW is a first symbol of a first PUCCH transmission in a slot determined for the PUCCH transmissions within the nominal TDW.

An end of an actual TDW is:
a last symbol of a last PUCCH transmission in a slot determined for the PUCCH transmission within the nominal TDW, if the actual TDW reaches the last PUCCH transmission within the nominal TDW; or
a last symbol of a PUCCH transmission before an event, if the event occurs which causes power consistency and phase continuity not to be maintained within the nominal time domain window across PUCCH transmissions between PUCCH repetitions within the nominal TDW, and the PUCCH transmission is in a slot determined for transmission of a PUCCH.

When PUCCH window restart (PUCCH-Window-Restart) is enabled, a start of a new actual TDW is a first symbol of a PUCCH transmission after the event which causes power consistency and phase continuity not to be maintained within the nominal time domain window, the event causes power consistency and phase continuity not to be maintained across the PUCCH transmissions between the PUCCH repetitions within the nominal TDW, and the PUCCH transmission is in the slot determined for transmission of the PUCCH.

Events that cause power consistency and phase continuity not to be maintained within the nominal time domain window (or events due to which power consistency and phase continuity cannot be maintained within the nominal time domain window) across the PUSCH transmissions of the PUSCH repetition type A scheduled by the DCI format 0_1 or the DCI format 0_2, or the PUSCH transmissions of the PUSCH repetition type A with the configured grant, or the PUSCH transmissions of the PUSCH repetition type B, or the PUSCH transmissions of the TB processing over multiple slots, or the PUCCH transmissions of the PUCCH repetition are as follows:
a downlink slot, or downlink reception, or downlink monitoring based on time division duplexing (time division duplexing, TDD) uplink and downlink common configuration (tdd-UL-DL-ConfigurationCommon) and a TDD uplink and downlink dedicated configuration (tdd-UL-DL-ConfigurationDedicated) for an unpaired spectrum; or
a gap between any two consecutive PUSCH transmissions, or a gap between any two consecutive PUCCH transmissions exceeds 13 symbols for a normal cyclic prefix or exceeds 11 symbols for an extended cyclic prefix; or
a gap between any two consecutive PUSCH transmissions, or a gap between any two consecutive PUCCH transmissions does not exceed 13 symbols, but another uplink transmission is scheduled between the two consecutive PUSCH transmissions or the two consecutive PUCCH transmissions; or
for the PUSCH transmissions of the PUSCH repetition type A, or the PUSCH repetition type B, or TB processing over multiple slots, a PUSCH transmission is dropped or canceled according to the clause 9, the clause 11.1, and the clause 11.2A or [6, TS 38.213]; or
for the PUCCH transmissions of the PUCCH repetition, a PUCCH transmission is dropped or canceled according to the clause 9, the clause 9.2.6, and the clause 11.1 of [6, TS 38.213]; or
for any two consecutive PUSCH transmissions of the PUSCH repetition type A or the PUSCH repetition type B, and when two channel sounding reference signal (sounding reference signal, SRS) resource sets are configured in an added or revised SRS resource set list (srs-ResourceSetToAddModList) or an added or revised SRS resource set list DCI0-2 (srs-ResourceSetToAddModListDCI-0-2) of an SRS resource set, and parameter usage (usage) of a higher layer parameter SRS resource set (SRS-ResourceSet) is set to “codebook” or “noncodebook”, different SRS resource set associations are used for the two PUSCH transmissions of the PUSCH repetition type A or the PUSCH repetition type B according to the clause 6.1.2.1 of TS 38.213; or
for any two consecutive PUCCH transmissions of the PUCCH repetition, and when a PUCCH resource used for repeated PUCCH transmissions by the UE includes a first spatial relationship and a second spatial relationship or a first power control parameter and a second power control parameter, as described in [10, TS 38. 321] and in the clause 7.2.1 of [6, TS 38.213],different spatial relationships or different power control parameters are used for the two PUCCH repetitions of the PUCCH repetition according to the clause 9.2.6 of [6, TS 38.213]; or
uplink timing adjustment is performed in response to a timing advance command according to the clause 4.2 of [6, TS 38.213]; or
frequency hopping is performed; or
for half-duplex UE with a degraded capability, a PUSCH transmission is dropped or canceled according to the clause 17.2 of [6, TS 38.213], or a gap between two consecutive PUSCH transmissions overlaps any symbol of downlink reception or downlink monitoring.

Optionally, the actual TDW spans a plurality of PUSCH transmissions of a PUSCH repetition type A scheduled by a DCI format 0_1 or 0_2, or a PUSCH repetition type A with a configured grant, or a PUSCH repetition type B, or TB processing over multiple slots, or a plurality of PUCCH transmissions of a PUCCH repetition. The actual TDW is created in response to frequency hopping, or in response to use of different SRS resource set associations for two PUSCH transmissions of a PUSCH repetition type A or a PUSCH repetition type B, or in response to use of different spatial relationships or different power control parameters for two PUCCH transmissions of a PUCCH repetition, or in response to any event due to which power consistency and phase continuity cannot be maintained within the nominal time domain window and that is not triggered by DCI or MAC-CE. The UE maintains power consistency and phase continuity within one actual TDW. The actual TDW spans a plurality of PUSCH transmissions of a PUSCH repetition type A scheduled by a DCI format 0_1 or 0_2, or a plurality of PUSCH transmissions of a PUSCH repetition type A with a configured grant, or a plurality of PUSCH transmissions of a PUSCH repetition type B, or a plurality of PUSCH transmissions of TB processing over multiple slots, or a plurality of PUCCH transmissions of across PUCCH repetitions. The actual TDW is created based on the UE capability in response to an event, other than frequency hopping, due to which power consistency and phase continuity cannot be maintained within the nominal time domain window and which is triggered by DCI or MAC-CE.

Based on the method shown in FIG. 5, the communication apparatus may determine the duration of the nominal time domain window based on at least one of the quantity of antenna combinations, the duration of the group-based nominal time domain window, and the correction value of the maximum demodulation reference signal DMRS bundling duration of the terminal apparatus, and determine the actual time domain window based on the duration. This can improve the precision of determining the duration of the nominal time domain window and/or the actual time domain window.

Based on a same concept, an embodiment of this application further provides a communication apparatus. The communication apparatus may include corresponding hardware structures and/or software modules for performing the functions shown in the foregoing method. A person skilled in the art should be easily aware that in combination with the units and the method steps in the examples described in embodiments disclosed in this application, this application can be implemented by using hardware or a combination of hardware and computer software. Whether a function is performed by hardware or hardware driven by computer software depends on particular application scenarios and design constraints of the technical solutions.

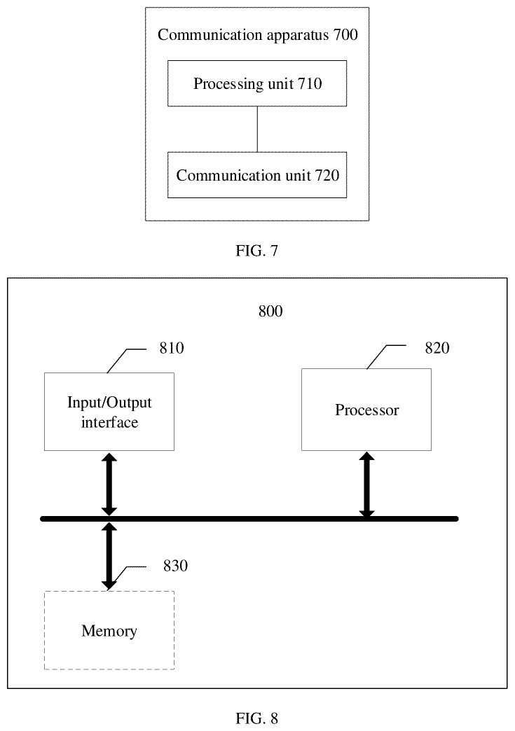

FIG. 7 to FIG. 9 are diagrams of structures of possible communication apparatuses according to embodiments of this application. The communication apparatuses may be configured to implement functions of the network apparatus and/or the terminal apparatus in the foregoing method embodiments, and therefore can also achieve beneficial effect of the foregoing method embodiments. In a possible implementation, the communication apparatus may be the terminal apparatus or the network apparatus. For related details and effect, refer to the descriptions in the foregoing embodiments.

As shown in FIG. 7, a communication apparatus 700 includes a processing unit 710 and a communication unit 720. The communication unit 720 may implement a corresponding communication function, and the processing unit 710 is configured to process data. The communication unit 720 may alternatively be a transceiver unit, an input/output interface, or the like. The communication apparatus 700 may be configured to implement functions of the terminal apparatus and/or the network apparatus in the method embodiment shown in FIG. 5.

For example, when the method shown in FIG. 5 is implemented, the processing unit 710 may be configured to determine duration of a nominal time domain window based on at least one of a quantity of antenna combinations, duration of a group-based nominal time domain window, and a correction value of maximum DMRS bundling duration of the terminal apparatus, and is configured to determine an actual time domain window of the terminal apparatus based on the duration of the nominal time domain window.

For a manner in which the processing unit 710 determines the duration of the nominal time domain window, refer to the descriptions in the method embodiment. Details are not described herein again.

In addition, if the communication apparatus 700 functions as the terminal apparatus, the communication unit 720 may be configured to receive one or more of first information, a capability query message, the group-based nominal time domain window, and a first correspondence, or is configured to send the correction value of the maximum DMRS bundling duration.

If the communication apparatus 700 functions as the terminal apparatus, the communication unit 720 may be configured to send one or more of the first information, the capability query message, the group-based nominal time domain window, and the first correspondence, or is configured to receive the correction value of the maximum DMRS bundling duration.

For meanings of the foregoing technologies, refer to the descriptions in the method embodiments. Details are not described again.

It may be further understood that in embodiments of this application, division into modules is an example, and is merely logical function division. During actual implementation, there may be another division manner. In addition, functional modules in embodiments of this application may be integrated into one processor, each module may exist alone physically, or two or more modules may be integrated into one module. The integrated module may be implemented in a form of hardware, or may be implemented in a form of a software functional module.

FIG. 8 shows the communication apparatus 800 according to an embodiment of this application. The communication apparatus 800 is configured to implement the method provided in this application. The communication apparatus 800 may be a communication apparatus to which the method is applied, a component in the communication apparatus, or an apparatus that can be used in a matching manner with the communication apparatus. The communication apparatus 800 may be a network device and/or a terminal apparatus. The communication apparatus 800 may be a chip system or a chip. In this embodiment of this application, the chip system may include a chip, or may include a chip and another discrete component. The communication apparatus 800 includes at least one processor 820, configured to implement the method provided in embodiments of this application. The communication apparatus 800 may further include an input/output interface 810, and the input/output interface may include an input interface and/or an output interface. In this embodiment of this application, the input/output interface 810 may be configured to communicate with another apparatus via a transmission medium, and a function of the input/output interface 810 may include sending and/or receiving. For example, when the communication apparatus 800 is the chip, the communication apparatus 800 performs transmission with another chip or device through the input/output interface 810. The processor 820 may be configured to implement the method shown in the foregoing method embodiments.

For example, the processor 820 may be configured to perform an action performed by the processing unit 710, and the input/output interface 810 may be configured to perform an action performed by the communication unit 720. Details are not described again.

Optionally, the communication apparatus 800 may further include at least one memory 830, configured to store program instructions and/or data. The memory 830 is coupled to the processor 820. The coupling in this embodiment of this application may be an indirect coupling or a communication connection between apparatuses, units, or modules in an electrical form, a mechanical form, or another form, and is used for information exchange between the apparatuses, the units, or the modules. The processor 820 may cooperate with the memory 830. The processor 820 may execute the program instructions stored in the memory 830. At least one of the at least one memory may be integrated with the processor.

In this embodiment of this application, the memory 830 may be a non-volatile memory such as a hard disk drive (hard disk drive, HDD) or a solid-state drive (solid-state drive, SSD), or may be a volatile memory (volatile memory) such as a random-access memory (random-access memory, RAM). The memory is any other medium that can carry or store expected program code in a form of instructions or a data structure and that can be accessed by a computer, but is not limited thereto. The memory in this embodiment of this application may alternatively be a circuit or any other apparatus that can implement a storage function, and is configured to store the program instructions and/or the data.

In this embodiment of this application, the processor 820 may be a general-purpose processor, a digital signal processor, an application-specific integrated circuit, a field programmable gate array or another programmable logic device, a discrete gate or transistor logic device, or a discrete hardware component, and may implement or execute the methods, steps, and logical block diagrams disclosed in embodiments of this application. The general-purpose processor may be a microprocessor or any conventional processor or the like. The steps of the method disclosed with reference to embodiments of this application may be directly performed by a hardware processor, or may be performed by using a combination of hardware in the processor and a software module.

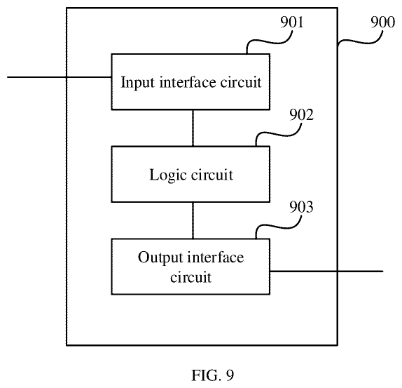

FIG. 9 shows a communication apparatus 900 according to an embodiment of this application. The communication apparatus 900 is configured to implement the method provided in this application. The communication apparatus 900 may be a communication apparatus to which the method shown in embodiments of this application is applied, a component in the communication apparatus, or an apparatus that can be used in a matching manner with the communication apparatus. The communication apparatus 900 may be a network device and/or a terminal apparatus. The communication apparatus 900 may be a chip system or a chip. In this embodiment of this application, the chip system may include a chip, or may include a chip and another discrete component. A part or all of the method provided in the foregoing embodiments may be implemented by hardware or software. When the method is implemented by hardware, the communication apparatus 900 may include an input interface circuit 901, a logic circuit 902, and an output interface circuit 903.

Optionally, an example in which the apparatus is configured to implement functions of a receiver is used. The input interface circuit 901 may be configured to perform a receiving action

performed by the communication unit 720, the output interface circuit 903 may be configured to perform a sending action performed by the communication unit 720, and the logic circuit 902 may be configured to perform an action performed by the processing unit 710. Details are not described

again. Optionally, during specific implementation, the communication apparatus 900 may be a chip or an integrated circuit.

Some or all of operations and functions performed by the communication apparatus described in the foregoing method embodiments of this application may be implemented by using the chip or the integrated circuit.

An embodiment of this application provides a computer-readable storage medium storing a computer program. The computer program includes instructions for performing the foregoing method embodiments.

An embodiment of this application provides a computer program product including instructions. When the computer program product runs on a computer, the computer is enabled to perform the foregoing method embodiments.

An embodiment of this application provides a communication system, including a terminal apparatus and a network apparatus. The terminal apparatus may perform actions of the terminal apparatus shown in this application. The network apparatus may be configured to perform an action of the network apparatus shown in the method embodiments of this application.

It may be understood that the processor in embodiments of this application may be a central processing unit (central processing unit, CPU), or may be another general-purpose processor, a digital signal processor (digital signal processor, DSP), an application-specific integrated circuit (application-specific integrated circuit, ASIC), a field programmable gate array (field programmable gate array, FPGA) or another programmable logic device, a transistor logic device, a hardware component, or any combination thereof. The general-purpose processor may be a microprocessor or may be any conventional processor or the like.

All or some of the foregoing embodiments may be implemented by using software, hardware, firmware, or any combination thereof. When software is used to implement the embodiments, all or a part of the embodiments may be implemented in a form of a computer program product. The computer program product includes one or more computer instructions. When the computer instructions are loaded and executed on a computer, the procedure or functions according to embodiments of this application are all or partially generated. The computer may be a general-purpose computer, a special-purpose computer, a computer network, or another programmable apparatus. The computer instructions may be stored in a computer-readable storage medium or may be transmitted from one computer-readable storage medium to another computer-readable storage medium. For example, the computer instructions may be transmitted from one website, computer, server, or data center to another website, computer, server, or data center in a wired (for example, through a coaxial cable, an optical fiber, or a digital subscriber line (digital subscriber line, DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a high-density digital video disc (digital video disc, DVD)), a semiconductor medium (for example, an SSD), or the like.

It should be noted that a part of this patent application document includes copyright-protected content. Except for making copies of patent documents of the Patent Office or recorded content of patent documents, the copyright owner reserves the copyright.

The network device and the terminal device in the foregoing apparatus embodiments correspond to the network device or the terminal device in the method embodiments. A corresponding module or unit performs a corresponding step. For example, a communication unit (a transceiver) performs a receiving step or a sending step in the method embodiments, and a step other than the sending step and the receiving step may be performed by a processing unit (a processor). For a function of a specific unit, refer to a corresponding method embodiment. There may be one or more processors.

Terminologies such as “component”, “module”, and “system” used in this specification are used to indicate computer-related entities, hardware, firmware, combinations of hardware and software, software, or software being executed. For example, a component may be, but is not limited to, a process that runs on a processor, a processor, an object, an executable file, an execution thread, a program, and/or a computer. As illustrated by using figures, both a computing device and an application that runs on the computing device may be components. One or more components may reside within a process and/or a thread of execution, and a component may be located on one computer and/or distributed between two or more computers. In addition, these components may be executed from various computer-readable media that store various data structures. For example, the components may communicate by using a local and/or remote process and based on, for example, a signal having one or more data packets (for example, data from two components interacting with another component in a local system, a distributed system, and/or across a network such as the Internet interacting with other systems by using the signal).

A person of ordinary skill in the art may be aware that, in combination with illustrative logical blocks (illustrative logical block) described in embodiments disclosed in this specification and steps (step) may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units may be integrated into one unit. When functions are implemented in the form of a software functional unit and sold or used as an independent product, the functions may be stored in a computer-readable storage medium.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A time domain window determining method, applied to a communication apparatus, and comprising:
determining duration of a nominal time domain window based on at least one of a quantity of antenna combinations, duration of a group-based nominal time domain window, and a correction value of maximum demodulation reference signal DMRS bundling duration of a terminal apparatus, wherein the group-based nominal time domain window corresponds to a group of terminal apparatuses, the group of terminal apparatuses comprises the terminal apparatus, and the correction value of the maximum DMRS bundling duration is related to channel state information; and
determining an actual time domain window of the terminal apparatus based on the duration of the nominal time domain window.

2. The method according to claim 1, wherein the communication apparatus is the terminal apparatus, and the method further comprises:
maintaining power consistency and phase continuity within the actual time domain window.

3. The method according to claim 1, wherein determining the duration of the nominal time domain window comprises:
determining the duration of the nominal time domain window based on the maximum DMRS bundling duration, continuous transmission time, and the quantity of antenna combinations of the terminal apparatus, wherein the continuous transmission time is determined based on resource scheduling information.

4. The method according to claim 1, wherein determining the duration of the nominal time domain window based on the group-based nominal time domain window comprises:
determining the duration of the nominal time domain window based on the maximum DMRS bundling duration, continuous transmission time, and the group-based nominal time domain window of the terminal apparatus, wherein the continuous transmission time is determined based on resource scheduling information.

5. The method according to claim 1, wherein determining the duration of the nominal time domain window comprises:
determining the duration of the nominal time domain window based on the maximum DMRS bundling duration, continuous transmission time, the quantity of antenna combinations, and the group-based nominal time domain window of the terminal apparatus, wherein the continuous transmission time is determined based on resource scheduling information.

6. The method according to claim 1, wherein the communication apparatus is the terminal apparatus, and the method further comprises:
sending first information, wherein the first information indicates at least one of the following information:
an index of an antenna working mode supported by the terminal apparatus;
an index of a quantity of antenna combinations supported by the terminal apparatus; and
the quantity of antenna combinations.

7. The method according to claim 1, wherein the quantity of antenna combinations comprises a quantity of antenna combinations corresponding to a data channel and/or a quantity of antenna combinations corresponding to a control channel.

8. The method according to claim 6, wherein the first information is terminal capability information, the communication apparatus is the terminal apparatus, and the method further comprises:
receiving a terminal capability query message from a network apparatus.

9. The method according to claim 1, wherein the communication apparatus is the network apparatus, and the method further comprises:
sending the terminal capability query message;
receiving the first information, wherein the first information indicates at least one of the following information:
the index of the antenna working mode supported by the terminal apparatus;
the index of the quantity of antenna combinations supported by the terminal apparatus; and
the quantity of antenna combinations.

10. The method according to claim 6, wherein the index of the antenna working mode supported by the terminal apparatus comprises an index of an antenna working mode of a physical channel supported by the terminal apparatus and/or an index of an antenna working mode of a control channel supported by the terminal apparatus.

11. An apparatus comprising:
at least one processor; and
one or more memories coupled to the at least one processor and storing program instructions for execution by the at least one processor to:
determine duration of a nominal time domain window based on at least one of a quantity of antenna combinations, duration of a group-based nominal time domain window, and a correction value of maximum demodulation reference signal DMRS bundling duration of a terminal apparatus, wherein the group-based nominal time domain window corresponds to a group of terminal apparatuses, the group of terminal apparatuses comprises the terminal apparatus, and the correction value of the maximum DMRS bundling duration is related to channel state information; and
determine an actual time domain window of the terminal apparatus based on the duration of the nominal time domain window.

12. The apparatus according to claim 11, wherein the apparatus is the terminal apparatus, and the one or more memories further storing program instructions for execution by the at least one processor to:
maintain power consistency and phase continuity within the actual time domain window.

13. The apparatus according to claim 11, wherein determine the duration of the nominal time domain window comprises:
determine the duration of the nominal time domain window based on the maximum DMRS bundling duration, continuous transmission time, and the quantity of antenna combinations of the terminal apparatus, wherein the continuous transmission time is determined based on resource scheduling information.

14. The apparatus according to claim 11, wherein determine the duration of the nominal time domain window based on the group-based nominal time domain window comprises:
determine the duration of the nominal time domain window based on the maximum DMRS bundling duration, continuous transmission time, and the group-based nominal time domain window of the terminal apparatus, wherein the continuous transmission time is determined based on resource scheduling information.

15. The apparatus according to claim 11, wherein determine the duration of the nominal time domain window comprises:
determine the duration of the nominal time domain window based on the maximum DMRS bundling duration, continuous transmission time, the quantity of antenna combinations, and the group-based nominal time domain window of the terminal apparatus, wherein the continuous transmission time is determined based on resource scheduling information.

16. The apparatus according to claim 11, wherein the apparatus is the terminal apparatus, and the one or more memories further storing program instructions for execution by the at least one processor to:
send first information, wherein the first information indicates at least one of the following information:
an index of an antenna working mode supported by the terminal apparatus;
an index of a quantity of antenna combinations supported by the terminal apparatus; and
the quantity of antenna combinations.

17. The apparatus according to claim 11, wherein the quantity of antenna combinations comprises a quantity of antenna combinations corresponding to a data channel and/or a quantity of antenna combinations corresponding to a control channel.

18. The apparatus according to claim 16, wherein the first information is terminal capability information, the apparatus is the terminal apparatus, and the one or more memories further storing program instructions for execution by the at least one processor to:
receive a terminal capability query message from a network apparatus.

19. The apparatus according to claim 11, wherein the apparatus is the network apparatus, and the one or more memories further storing program instructions for execution by the at least one processor to:
send the terminal capability query message;
receive the first information, wherein the first information indicates at least one of the following information:
the index of the antenna working mode supported by the terminal apparatus;
the index of the quantity of antenna combinations supported by the terminal apparatus; and
the quantity of antenna combinations.

20. The apparatus according to claim 16, wherein the index of the antenna working mode supported by the terminal apparatus comprises an index of an antenna working mode of a physical channel supported by the terminal apparatus and/or an index of an antenna working mode of a control channel supported by the terminal apparatus.
